(19) United States
(12) Patent Application Publication
(10) Pub. No.: US 2026/0189300 A1
(43) Pub. Date: Jul. 2, 2026

(54) ROUTING PROTOCOL FOR AVOIDING SPACE DEBRIS IN COMMUNICATIONS

(71) Applicant: Wells Fargo Bank, N.A, San Francisco, CA (US)

(72) Inventor: Rameshchandra Bhaskar Ketharaju, Hyderabad (IN)

(21) Appl. No.: 19/008,063

(22) Filed: Jan. 2, 2025

(51) Int. Cl. H04B 10/118; H04B 10/70

(52) U.S. Cl. CPC H04B 10/118; H04B 10/70

(57) ABSTRACT

Systems and techniques may generally be used for communication with a satellite. An example technique may include identifying a path from a first device to a second device, at least one of the first device or the second device being a satellite, determining a set of three or more celestial objects, wherein locations of the set of three or more celestial objects and a location of the first device define a field of view, and retrieving debris vector information corresponding to space debris that is projected to intersect a portion of the field of view over a specified time window. The example technique may include determining, within the specified time window, a sub-window where the field of view is clear from the space debris based on the debris vector information, and outputting an indication of the sub-window for sending a signal from the first device to the second device.

### BACKGROUND

Space debris is any material, human made or natural, that is floating in space, whether in a stable orbit, a decaying orbit, or exiting Earth's gravitational influence. Space debris has implications for satellite navigation, orbital decisions, and line of sight. Satellites may be in any of various orbits, such as a low earth orbit (LEO), which includes orbits that are at or below 2,000 kilometers above the Earth's surface (with some having a higher apogee), a medium earth orbit (MEO), which includes orbits above 2,000 kilometers up to around geosynchronous orbit (e.g., around 35,000 to 36,000 kilometers). An example type of satellite in MEO includes global positioning system (GPS) satellites, which orbit the Earth twice per day. Geosynchronous satellites may remain stationary with respect to a location on Earth because they rotate at the same rate as the Earth. Above geosynchronous orbit is high earth orbit (HEO), which has very few human made satellites.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a diagram showing satellite communication in accordance with some examples.

FIG. 2 illustrates a diagram showing a debris field interfering with satellite communication in accordance with some examples.

FIG. 3 illustrates a block diagram showing a node communication path in accordance with some examples.

FIG. 4 illustrates example circuitry in a node in accordance with some examples.

FIG. 5 illustrates a flowchart showing a technique for communication to or from a satellite in accordance with some examples.

FIG. 6 illustrates generally an example of a block diagram of a machine upon which any one or more of the techniques discussed herein may perform in accordance with some examples.

### DETAILED DESCRIPTION

The systems and techniques described herein provide a routing protocol for communications to avoid obstructions in space, for example for communicating to or from a satellite. The obstructions may include space debris, satellites, or other obstructions that may interfere with a communication, such as an aurora, solar rays, etc. Communications may include communications between satellites, between a terrestrial-based device (e.g., a ground station, a vehicle, etc.) and a satellite, between a plane or other aerial vehicle and a satellite, or the like.

The systems and techniques described herein may be used to prevent or minimize interference with a signal being sent to or from a satellite, for example when an object may be present between the satellite and another communication device. A communication window in space may be determined based on a field of view from a first device to a second device, where a satellite may be the first or second device (or both devices may be a satellite). The communication window may be an area or an extruded conic section in space. The communication window may include a physical location portion and optionally a timing window.

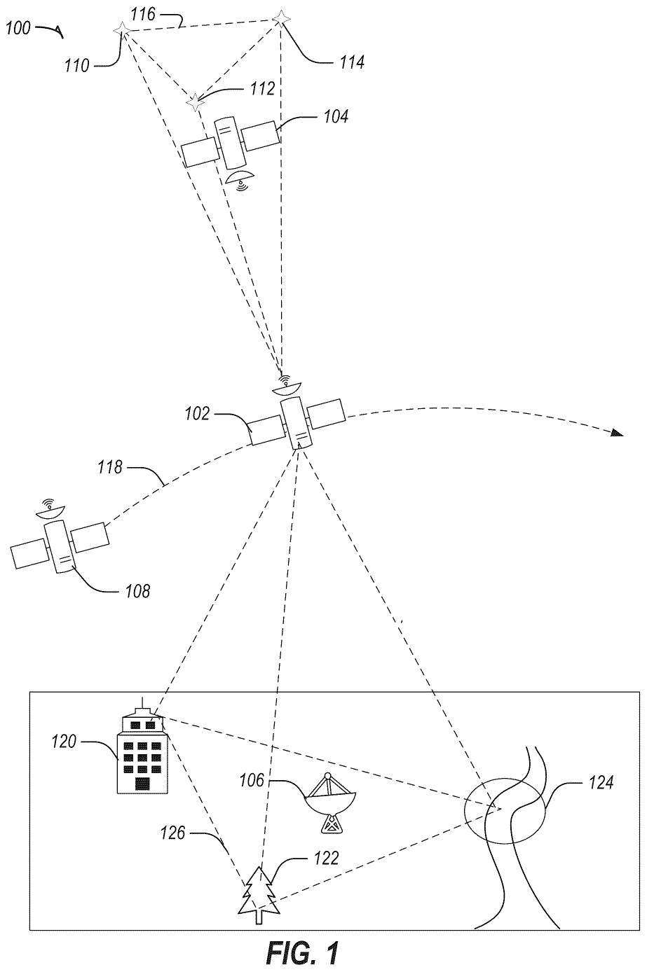

FIG. 1 illustrates a diagram 100 showing satellite communication in accordance with some examples. The diagram 100 illustrates a first satellite 102 that may be in communication with a second satellite 104, a ground device 106, or other device. Consider the example of the first satellite 102 in communication with the second satellite 104. In this example, the first satellite 102 has a field of view that includes the second satellite 104. The first satellite 102 may capture an image or otherwise capture information related to one or more objects in the field of view. For example, the first satellite 102 may detect or capture an image to detect a set of stars 110, 112, and 114 that are located in a field of view of the first satellite 102 in the direction of the second satellite 104. The set of stars 110, 112, and 114 may be selected such that they form a triangle 116 (or other area if more than three stars are in the set of stars, for example a rectangle with four stars) with the second satellite 104 inside the triangle (e.g., when projected into the plane of the triangle), as viewed from the field of view of the first satellite 102.

After identifying the triangle 116, the first satellite 102 (or other processing device, such as a ground-based processing device) may determine whether any objects are present in the triangle 116 when viewed from the first satellite 102. For example, an image may be captured by the first satellite 102, and the image may be evaluated to determine whether there is anything other than the second satellite 104 in the triangle 116 in the image. Objects in the triangle 116 may include debris, another satellite, etc. While an object may be located behind the second satellite 104 in space and thus not block communication between the first satellite 102, but appear in the triangle 116, creating a false positive, there are no false negatives in this setup. For example, as long as the only object in the triangle 116 is the second satellite 104 from the perspective of the first satellite 102, nothing will block a communication between the first and second satellites 102 and 104. A signal may be sent between the satellites 102 and 104 within the triangle 116 (e.g., accounting for some spatial movement of the first or second satellites 102 or 104) when no other object appears in the triangle 116.

When the triangle 116 does include an object other than the second satellite 104, a second set of stars may be selected. In some examples the second set of stars may include one or more of the stars 110, 112, or 114 (e.g., one or two). In some examples, the second set of stars may be within or along an edge or at a vertex of the first set of stars. For example, star 110 may be one star of the second set of stars while two other stars within the triangle 116 may be selected as the other two vertices of the new triangle. In some examples, the new triangle represented by the second set of stars may be strictly smaller than the triangle 116. In other examples, the new triangle may have a smaller area but a larger perimeter (e.g., a more isosceles triangle) or a larger area but a smaller perimeter (e.g., a more equilateral triangle). The second set of stars may be selected from an initial larger set of stars of which the first set of stars was also selected. When no set of stars is selectable that does not include some object in a projected field of view, a third satellite 108 may be used. In an example, the third satellite 108 may replace the first satellite 102 for communicating with the second satellite 104 (e.g., when a ground to or from second satellite 104 communication is to occur). In another example, the third satellite 108 may relay a communication to or from the first satellite 102 from or to the second satellite 104 (e.g., when a satellite to satellite communication is to occur between the satellites 102 and 104). The third satellite 108 may use a similar technique to determine a clear path to communicate with the second satellite 104. In some examples, the third satellite 108 may be on a similar or same path or orbit 118 as the first satellite 102, and may use the same triangle 116 or the like.

In an example, the first satellite 102 may communicate with a ground station 106. The first satellite 102 may perform a similar technique for determining a clear path to communicate to or from the ground station 106 as described above with respect to the second satellite 104. For example, a set of objects (e.g., 120, 122, 124) may be identified that form a triangle 126 (or other area) with the ground station 106 within the triangle 126. The set of objects may be selected based on visible objects from a point of view of the first satellite 102 (e.g., as captured in an image). As described above, a smaller set of objects may be used if there is an object in the triangle 126.

The first satellite 102, the second satellite 104, or the third satellite 108 may be a satellite in a low earth orbit, a medium earth orbit, a geosynchronous orbit, or the like. In some examples, instead of communicating with the second satellite 104, the first satellite 102 may communicate with a device beyond geosynchronous earth orbit, such as an object on or orbiting the moon, a remote device (e.g., at a LaGrange point, travelling along a particular path in space, or the like), orbiting or on Mars, etc. In an example, a satellite or device may be in a low area platform (˜1 km), a high area platform (HAP) (˜20 km), a low earth orbit (LEO) (˜300km), a medium earth orbit (MEO) (˜7000 km), a geosynchronous orbit (GEO) (˜36000 km), or the like.

An accurate and unobstructed line of sight is particularly challenging and important in quantum communications due to the nature of quantum entanglement. In some examples, communication among or between devices (e.g., the first satellite 102 and another device) may be configured differently for different communications. For example, the first satellite 102 may establish an uplink protocol, a downlink protocol, or lateral protocol for communicating with the second satellite 104 (or other device). In some examples, a protocol may be unique to the two devices or set of devices (e.g., along a chain) that are communicating. For example, a first protocol may be used for communicating from the first satellite 102 to the second satellite 104 (e.g., via a lateral communication with the third satellite 108 as an intermediary), while a second protocol may be used for communicating from the second satellite 104 to the first satellite 102 (e.g., directly from the second satellite 104 to the first satellite 102). A satellite (e.g., any of 102, 104, 108, etc.) or a ground station (e.g., 106) may include a photon ray device to send a signal. These devices may include a quantum repeater or relay.

In an example, a precise line of sight may be used for sending a photon stream. The precise line of sight may include an identification of a specific point (e.g., having a de minimis radius) on an orbiting or other object. For example, a particular location on a satellite may be identified, such as with a light, reflector, decal, paint, etc.

When considering whether to initiate communication based on the triangle 116 or the triangle 126, an additional factor beyond whether there is an object in the triangle 116 or the triangle 126 may be used. For example, an additional factor may include a degree of sunlight (e.g., sunrise, sunset, day, night, etc.), solar activity (e.g., flares, coronas, etc.), eccentricity, inclination, transmitter mount type, declination, right accession, elliptical latitude, elliptical longitude, availability, line of sight, humidity (e.g., atmospheric condition), apsides of a satellite for example with respect to the moon or the sun, noise of aurorae, time of zero line of sight with sun or moon, or the like. For triangle 126, in particular, weather factors may be considered, such as cloud coverage, visibility, wildfires, etc.

In an example, a communication is to occur between the second satellite 104 and the ground station 106. In this example, various routings may be used, such as via the first satellite 102, via the third satellite 108, directly, or the like. A communication protocol may be selected for this communication, and that protocol may be changed based on conditions and a debris field. For example, the ground station 106 may send a message to the second satellite 104 directly but then debris or a cloud cover may occur, so that sending a message back from the second satellite 104 to the ground station 106 directly is infeasible. In this example, such as when the second satellite 104 is in a stationary orbit relative to the ground station 106, the debris or cloud cover may last a long period of time. To avoid the debris or cloud cover, the first satellite 102 may be used when a clear path to or from the second satellite 104 is available (e.g., as it travels along the trajectory 118). The first satellite 102 may receive a message from the second satellite 104, and then determine whether the first satellite 102 may send to the ground station 106, or whether another relay is to be used (e.g., the third satellite 108).

In some examples, a communication area or protocol may be selected based on a known path of debris (e.g., space debris that is tracked, such as by NASA). The direction, speed, and size of the debris may be considered for when to initiate a communication.

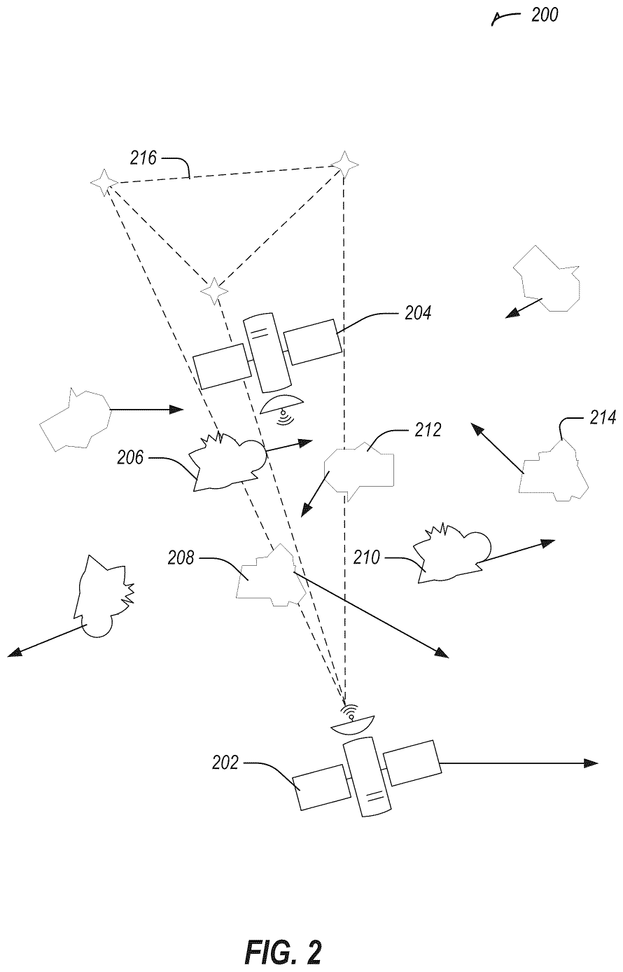

FIG. 2 illustrates a diagram showing a debris field interfering with satellite communication in accordance with some examples. While FIG. 2 illustrates the debris field, satellites, field of view 216, and satellites 202 and 204 visually, determination of a clear field of view does not require any visual representation.

As described above, three celestial or terrestrial objects may be used, along with a satellite (e.g., the satellite 202) or ground station to define a field of view 216.

Debris 206 and debris 208 are currently in the field of view 216, although debris 208 is moving quickly (indicated in FIG. 2 by a longer vector) and thus is likely to be clear of the field of view 216 soon. Debris 212 is not fully in the field of view 216, but is entering and likely to obstruct the field of view 216 soon. Debris 210 is unlikely to enter the field of view 216, although it is moving slower than the satellite 202 (e.g., indicated by the instantaneous vector shown as a line with an arrow), so there may be an issue as the satellite 202 moves along its orbit. Similarly, debris 214 is unlikely to enter the field of view 216.

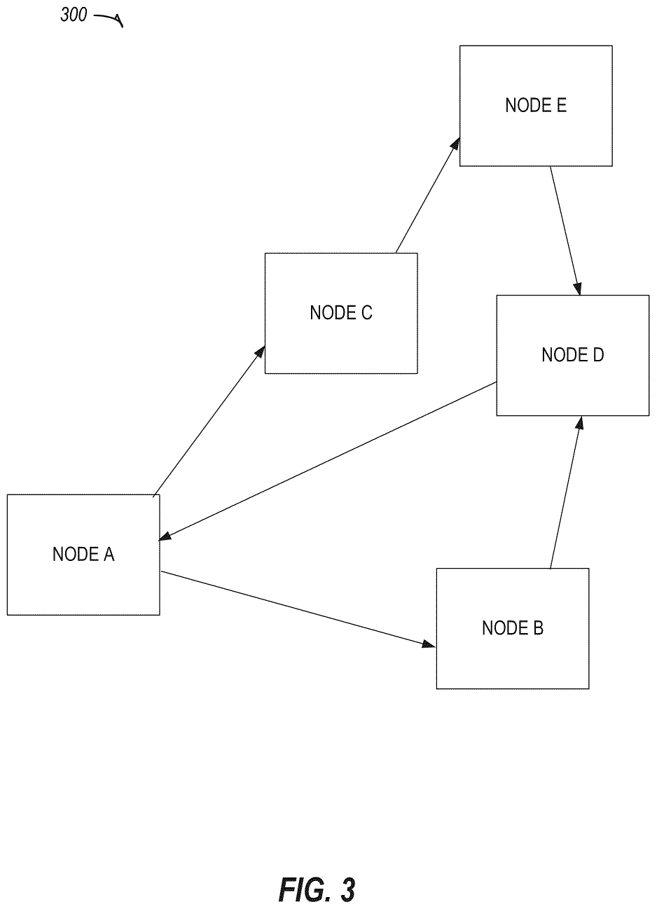

FIG. 3 illustrates a block diagram 300 showing a node communication path in accordance with some examples. The block diagram 300 includes a node spanning network of edges among nodes. In some examples, the node network in the block diagram 300 may be a subset of a larger node network (e.g., with entry and exit paths from node A, for example). The node network in the block diagram 300 is fully spanned, meaning a communication may be sent from any node to any other node along the directional edges, although some paths may require more hops than others (e.g., node C to node E uses a single edge, while node B to node E must traverse each of nodes D, A, and C before arrival). Because the edges are directional, a communication may follow a different path from one node to another than it does to return. For example, from node D to A is a direct edge, but from A back to D is either through node B or nodes C and E. The nodes may change position over time (e.g., when representing a satellite or other movable device), or may be static (e.g., a ground station that does not move). The edges may change in connection or direction over time (e.g., in response to environmental conditions, debris, movement of the nodes, etc.). Some aspects, even of moving nodes may be fixed. For example an IP protocol may be static or dynamic, while typically a country of origin or control may not change or change very rarely.

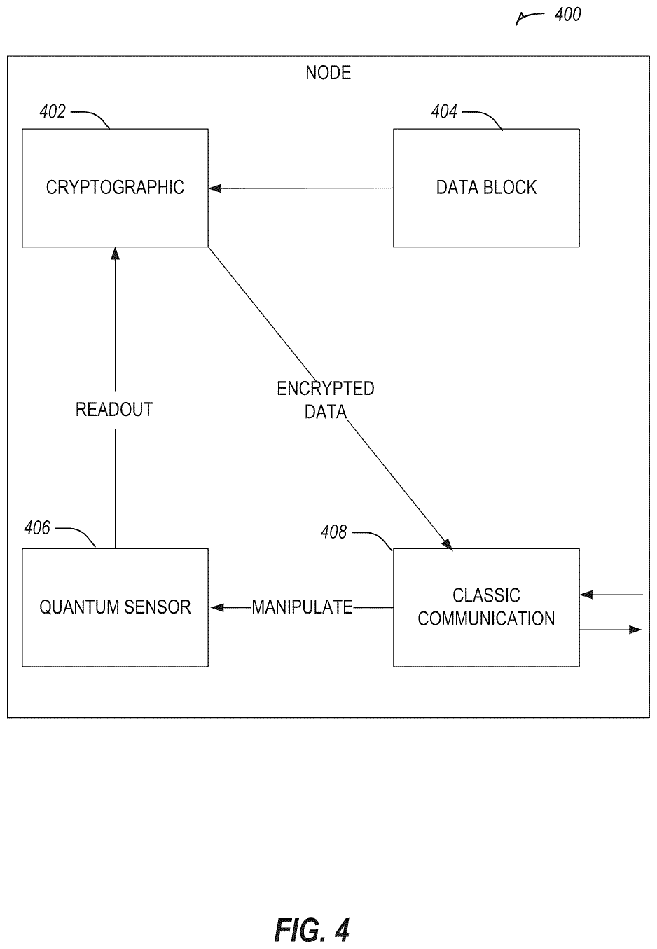

FIG. 4 illustrates example circuitry in a node 400 in accordance with some examples. The node 400 includes circuitry for communication, generation of cryptographic data, quantum data, etc., storage, and processing circuitry. The node 400 may be on a satellite, in some examples. The node 400 shown in FIG. 4 includes cryptographic circuitry 402, which may be used to generate, check, or deduce cryptographic key information. A data block 404 may be used to store cryptographic information, such as a list of one time pads or passwords, previously stored key information, a key generation algorithm, or the like. The node 400 includes classic communication circuitry 408 to communicate off of the node 400. The classic communication circuitry 408 may be used to send a received signal to a quantum sensor 406, which may interpret quantum data (e.g., a paired quantum bit. The quantum sensor 406 may send data related to the quantum data to the cryptographic circuitry 402 (e.g., a readout of entropy, a decimal value of a quantum bit, etc. The cryptographic circuitry 402 may use the data to generate or evaluate a key. A cryptographic key may be used to generate encrypted data (e.g., a message from the data block 404) to the classic communication circuitry 408, which may send the encrypted data to another node.

Each measurement of a quantum entangled particle may produce a random number using any suitable process to quantify the measurement into the random number. In some examples, a stream or multiple instances of a pair of entangled particles may be used to generate the random number with a desired bit length.

In an example, a random number generator of the node 400 (e.g., part of the cryptographic circuitry 402) may produce a random number based on measurements of a quantum derived seed comprising quantum entangled particles, wherein the node 400 measures a first particle in a pair of quantum entangled particles and wherein a second node measures a second particle in the pair of quantum entangled particles. In some examples, by using a pair of entangled particles, a measurement of the first particle at the node 400 may produce the same random number as a separate measurement of the second particle at the second node. This may provide a device for secure communication of random numbers to different nodes in the computing network.

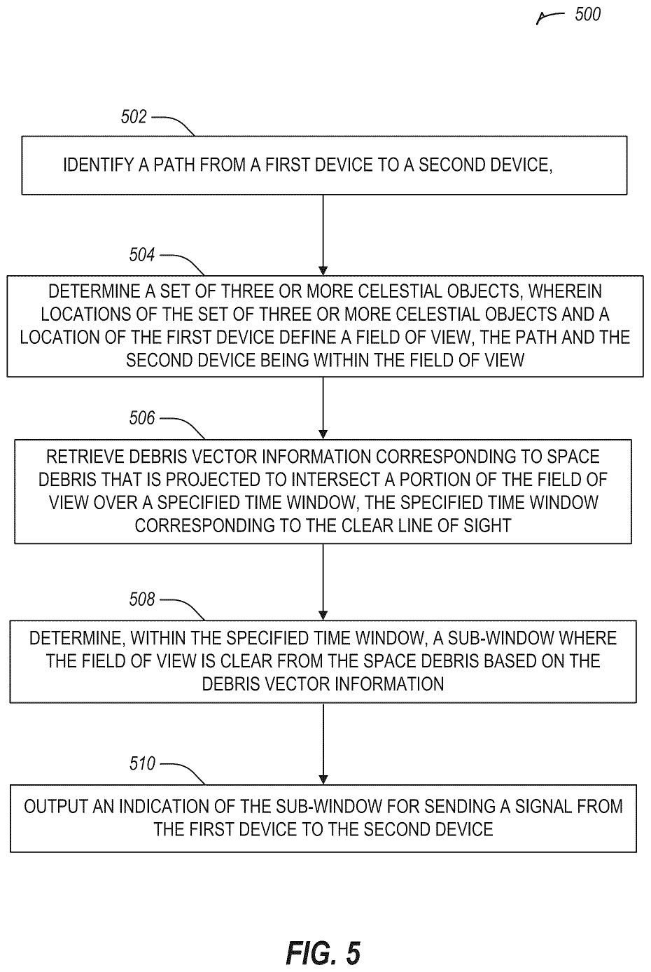

FIG. 5 illustrates a flowchart showing a technique 500 for communication to or from a satellite in accordance with some examples. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 1 (e.g., the banker device 102 of FIG. 1) or 6.

The technique 500 includes an operation 502 to identify a path from a first device to a second device, at least one of the first device or the second device being a satellite. The first device or the second device may be a satellite that is orbiting in a low earth orbit. The first device or the second device may be a satellite that is orbiting in a geosynchronous orbit. The first device or the second device may be a satellite that is orbiting in a medium earth orbit. In some examples, the first device or the second device include a quantum repeater. In an example, the path includes a clear line of sight. The clear line of sight may be limited by an orbit of the satellite, the satellite being in low earth orbit.

The technique 500 includes an operation 504 to determine a set of three or more celestial objects, wherein locations of the set of three or more celestial objects and a location of the first device define a field of view, the path and the second device being within the field of view. In an example, at least one of the set of three or more celestial objects is a star.

The technique 500 includes an operation 506 to retrieve debris vector information corresponding to space debris that is projected to intersect a portion of the field of view over a specified time window, the specified time window corresponding to the clear line of sight.

The technique 500 includes an operation 508 to determine, within the specified time window, a sub-window where the field of view is clear from the space debris based on the debris vector information. Ina n example, the sub-window is sufficiently long to allow the signal to be sent to the second satellite along the path.

The technique 500 includes an operation 510 to output an indication of the sub-window for sending a signal from the first device to the second device. The signal may include a quantum entangled photon, the quantum entangled photon entangled with a second photon generated at the first satellite, the quantum entangled photon and the second photon used to generate a random number at the first and second satellites for secure communication.

The technique 500 may include an operation to send the signal from the first satellite to the second satellite during the sub-window. The technique 500 may include selecting a second set of three or more celestial objects, and wherein locations of the second set of three or more celestial objects and the location of the first satellite define a more narrow field of view than the field of view, and further comprising determining a second sub-window where the more narrow field of view is clear from the space debris.

In an example, the technique 500 includes an operation to receive an indication of an incoming aurora and determine whether the sub-window includes interference from the aurora. In this example, the technique 500 may include outputting the indication of the sub-window in response to determining that the sub-window does not include interference from the aurora. In this example, the technique 500 may include identification of a third satellite to send the signal to act as a relay between the first satellite and the second satellite. In this example, the technique 500 may include identification of at least one more sub-window for resending the signal for error correction.

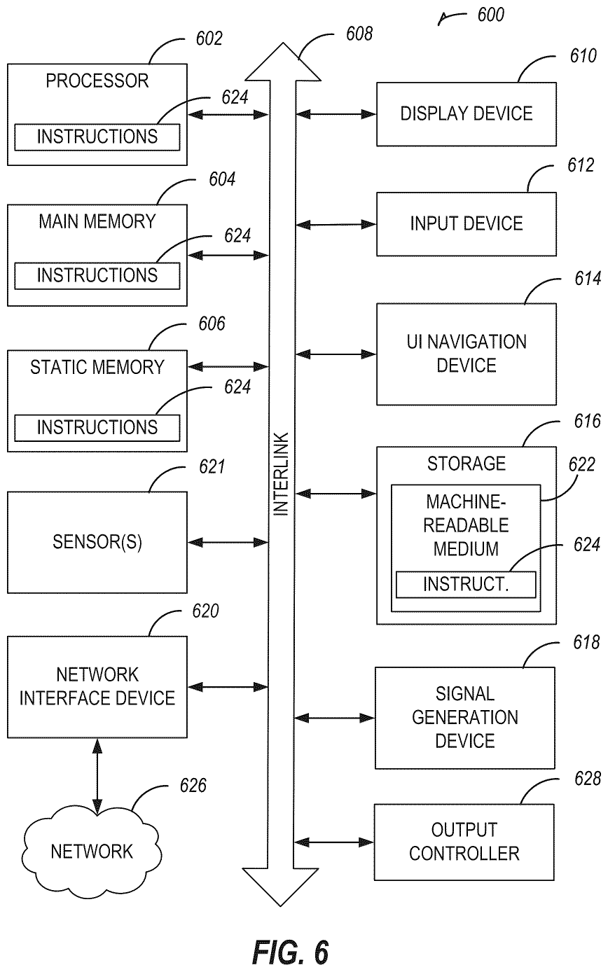

FIG. 6 illustrates generally an example of a block diagram of a machine 600 upon which any one or more of the techniques (e.g., methodologies) discussed herein may perform in accordance with some examples. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: identifying a path having clear line of sight from a first satellite to a second satellite; determining a set of three or more celestial objects, wherein locations of the set of three or more celestial objects and a location of the first satellite define a field of view, the path and the second satellite being within the field of view; retrieving debris vector information corresponding to space debris that is projected to intersect a portion of the field of view over a specified time window, the specified time window corresponding to the clear line of sight; determining, within the specified time window, a sub-window where the field of view is clear from the space debris based on the debris vector information; and outputting an indication of the sub-window for sending a signal from the first satellite to the second satellite.

In Example 2, the subject matter of Example 1 includes, sending the signal from the first satellite to the second satellite during the sub-window.

In Example 3, the subject matter of Examples 1-2 includes, wherein the signal includes a quantum entangled photon, the quantum entangled photon entangled with a second photon generated at the first satellite, the quantum entangled photon and the second photon used to generate a random number at the first and second satellites for secure communication.

In Example 4, the subject matter of Examples 1-3 includes, wherein at least one of the set of three or more celestial objects is a star.

In Example 5, the subject matter of Examples 1-4 includes, wherein the first satellite is orbiting in a low earth orbit and the second satellite is orbiting in a geosynchronous orbit.

In Example 6, the subject matter of Examples 1-5 includes, wherein the first satellite is orbiting in a low earth orbit and the second satellite is orbiting in a low earth orbit.

In Example 7, the subject matter of Examples 1-6 includes, wherein the sub-window is sufficiently long to allow the signal to be sent to the second satellite along the path.

In Example 8, the subject matter of Examples 1-7 includes, wherein the clear line of sight is limited by an orbit of the satellite, the satellite being in low earth orbit.

In Example 9, the subject matter of Examples 1-8 includes, wherein the first satellite and the second satellite include respective quantum repeaters.

In Example 10, the subject matter of Examples 1-9 includes, selecting a second set of three or more celestial objects, and wherein locations of the second set of three or more celestial objects and the location of the first satellite define a more narrow field of view than the field of view, and further comprising determining a second sub-window where the more narrow field of view is clear from the space debris.

In Example 11, the subject matter of Examples 1-10 includes, receiving an indication of an incoming aurora; and determining whether the sub-window includes interference from the aurora.

In Example 12, the subject matter of Example 11 includes, wherein outputting the indication of the sub-window occurs in response to determining that the sub-window does not include interference from the aurora.

In Example 13, the subject matter of Examples 11-12 includes, wherein the indication of the sub-window includes identification of a third satellite to send the signal to act as a relay between the first satellite and the second satellite.

In Example 14, the subject matter of Examples 11-13 includes, wherein the indication of the sub-window includes identification of at least one more sub-window for resending the signal for error correction.

Example 15 is a method comprising: identifying a path having clear line of sight to a ground station from a satellite; determining a set of three or more terrestrial objects, wherein locations of the set of three or more terrestrial objects and a location of the satellite define a field of view, the path and the ground station being within the field of view; retrieving debris vector information corresponding to space debris that is projected to intersect a portion of the field of view over a specified time window, the specified time window corresponding to the clear line of sight; determining, within the specified time window, a sub-window where the field of view is clear from the space debris based on the debris vector information; and outputting an indication of the sub-window for sending a signal from the satellite to the ground station.

In Example 16, the subject matter of Example 15 includes, wherein the satellite is orbiting in a geosynchronous orbit.

In Example 17, the subject matter of Examples 15-16 includes, receiving an indication of an incoming aurora; and determining whether the sub-window includes interference from the aurora; and wherein outputting the indication of the sub-window includes identifying a second ground station to receive the signal instead of the ground station, the second ground station being located closer to the equator than the ground station.

In Example 18, the subject matter of Examples 15-17 includes, wherein the signal includes a quantum entangled photon, the quantum entangled photon entangled with a second photon generated at the satellite, the quantum entangled photon and the second photon used to generate a random number at the ground station and the satellite for secure communication.

Example 19 is a method comprising: identifying a path having clear line of sight to a first satellite orbiting in a medium earth orbit from a second satellite orbiting in a geosynchronous orbit; determining a set of three or more terrestrial objects, wherein locations of the set of three or more terrestrial objects and a location of the second satellite define a field of view, the path and the first satellite being within the field of view; retrieving debris vector information corresponding to space debris that is projected to intersect a portion of the field of view over a specified time window, the specified time window corresponding to the clear line of sight; determining, within the specified time window, a sub-window where the field of view is clear from the space debris based on the debris vector information; and outputting an indication of the sub-window for sending a signal from the second satellite to the first satellite.

In Example 20, the subject matter of Example 19 includes, wherein the signal includes a quantum entangled photon, the quantum entangled photon entangled with a second photon generated at the second satellite, the quantum entangled photon and the second photon used to generate a random number at the first and second satellites for secure communication.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
identifying a path having clear line of sight from a first satellite to a second satellite;
determining a set of three or more celestial objects, wherein locations of the set of three or more celestial objects and a location of the first satellite define a field of view, the path and the second satellite being within the field of view;
retrieving debris vector information corresponding to space debris that is projected to intersect a portion of the field of view over a specified time window, the specified time window corresponding to the clear line of sight;
determining, within the specified time window, a sub-window where the field of view is clear from the space debris based on the debris vector information; and
outputting an indication of the sub-window for sending a signal from the first satellite to the second satellite.

2. The method of claim 1, further comprising sending the signal from the first satellite to the second satellite during the sub-window.

3. The method of claim 1, wherein the signal includes a quantum entangled photon, the quantum entangled photon entangled with a second photon generated at the first satellite, the quantum entangled photon and the second photon used to generate a random number at the first and second satellites for secure communication.

4. The method of claim 1, wherein at least one of the set of three or more celestial objects is a star.

5. The method of claim 1, wherein the first satellite is orbiting in a low earth orbit and the second satellite is orbiting in a geosynchronous orbit.

6. The method of claim 1, wherein the first satellite is orbiting in a low earth orbit and the second satellite is orbiting in a low earth orbit.

7. The method of claim 1, wherein the sub-window is sufficiently long to allow the signal to be sent to the second satellite along the path.

8. The method of claim 1, wherein the clear line of sight is limited by an orbit of the satellite, the satellite being in low earth orbit.

9. The method of claim 1, wherein the first satellite and the second satellite include respective quantum repeaters.

10. The method of claim 1, further comprising selecting a second set of three or more celestial objects, and wherein locations of the second set of three or more celestial objects and the location of the first satellite define a more narrow field of view than the field of view, and further comprising determining a second sub-window where the more narrow field of view is clear from the space debris.

11. The method of claim 1, further comprising:
receiving an indication of an incoming aurora; and
determining whether the sub-window includes interference from the aurora.

12. The method of claim 11, wherein outputting the indication of the sub-window occurs in response to determining that the sub-window does not include interference from the aurora.

13. The method of claim 11, wherein the indication of the sub-window includes identification of a third satellite to send the signal to act as a relay between the first satellite and the second satellite.

14. The method of claim 11, wherein the indication of the sub-window includes identification of at least one more sub-window for resending the signal for error correction.

15. A method comprising:
identifying a path having clear line of sight to a ground station from a satellite;
determining a set of three or more terrestrial objects, wherein locations of the set of three or more terrestrial objects and a location of the satellite define a field of view, the path and the ground station being within the field of view;
retrieving debris vector information corresponding to space debris that is projected to intersect a portion of the field of view over a specified time window, the specified time window corresponding to the clear line of sight;
determining, within the specified time window, a sub-window where the field of view is clear from the space debris based on the debris vector information; and
outputting an indication of the sub-window for sending a signal from the satellite to the ground station.

16. The method of claim 15, wherein the satellite is orbiting in a geosynchronous orbit.

17. The method of claim 15, further comprising:
receiving an indication of an incoming aurora; and
determining whether the sub-window includes interference from the aurora;
wherein outputting the indication of the sub-window includes identifying a second ground station to receive the signal instead of the ground station, the second ground station being located closer to the equator than the ground station.

18. The method of claim 15, wherein the signal includes a quantum entangled photon, the quantum entangled photon entangled with a second photon generated at the satellite, the quantum entangled photon and the second photon used to generate a random number at the ground station and the satellite for secure communication.

19. A method comprising:
identifying a path having clear line of sight to a first satellite orbiting in a medium earth orbit from a second satellite orbiting in a geosynchronous orbit;
determining a set of three or more terrestrial objects, wherein locations of the set of three or more terrestrial objects and a location of the second satellite define a field of view, the path and the first satellite being within the field of view;
retrieving debris vector information corresponding to space debris that is projected to intersect a portion of the field of view over a specified time window, the specified time window corresponding to the clear line of sight;
determining, within the specified time window, a sub-window where the field of view is clear from the space debris based on the debris vector information; and
outputting an indication of the sub-window for sending a signal from the second satellite to the first satellite.

20. The method of claim 19, wherein the signal includes a quantum entangled photon, the quantum entangled photon entangled with a second photon generated at the second satellite, the quantum entangled photon and the second photon used to generate a random number at the first and second satellites for secure communication.
